(19) United States
(12) Patent Application Publication
(10) Pub. No.: US 2019/0234220 A1
(43) Pub. Date: Aug. 1, 2019

(54) METHOD FOR PRODUCING TURBINE BLADE

(71) Applicant: MITSUBISHI HITACHI POWER SYSTEMS, LTD., Kanagawa (JP)

(72) Inventors: Daisuke YOSHIDA, Kanagawa (JP); Taiji TORIGOE, Tokyo (JP); Masaki TANEIKE, Tokyo (JP); Naotoshi OKAYA, Kanagawa (JP); Yoshiyuki INOUE, Kanagawa (JP)

(21) Appl. No.: 16/313,992

(22) PCT Filed: Sep. 25, 2017
(86) PCT No.: PCT/JP2017/034426

§ 371 Date: Dec. 28, 2018

(30) Foreign Application Priority Data
Oct. 7, 2016 (JP) 2016-198778

(51) Int. Cl. F01D 5/28; C23C 28/04; C23C 4/02; C23C 4/073; C23C 4/11; C23C 4/18

(52) U.S. Cl. CPC F01D 5/288; C23C 28/042; C23C 4/02; C23C 4/073; C23C 4/11; C23C 4/18; F05D 2300/2118; F05D 2230/40; F05D 2300/611; F05D 2300/175; F05D 2300/701; F05D 2300/2112; F05D 2230/90

(57) ABSTRACT

A method for producing a turbine blade includes forming an undercoat on a surface of a base material of a turbine blade, which is formed of a Ni-based alloy material, the undercoat being formed of a metallic material having a higher oxidation-resisting property than that of the base material, performing diffusing treatment for heating the base material having the undercoat formed thereon and diffusing a part of the undercoat on the base material side, and forming a topcoat on a surface of the undercoat after the diffusing treatment is performed, the topcoat being formed of a material having a lower thermal conductivity than that of the base material and the undercoat.

### TECHNICAL FIELD

The present invention relates to a method for producing a turbine blade.

### BACKGROUND ART

A gas turbine includes a compressor and a combustor. The compressor takes in and compresses an air to produce a high-temperature and high-pressure compressed air. The combustor burns the compressed air by supplying fuel to the compressed air. As the turbine in a vehicle cabin, a plurality of stator blades and rotor blades are alternately arranged. In the turbine, the rotor blades are rotated by a high-temperature and high-pressure combustion gas generated from the compressed air. With the rotation, a thermal energy is converted into a rotational energy.

The turbine blades such as the stator blades and the rotor blades are exposed in a high temperature environment, and thus are formed of metallic materials having a high heat-resisting property. Further, thermal barrier coating (TBC) is formed on the turbine blades in order to protect the turbine blades from a high temperature. As the thermal barrier coating, for example, an undercoat is formed on a surface of a base material of the turbine blade, and a topcoat is formed on a surface of the undercoat.

### CITATION LIST

### Patent Document

Patent Document 1: JP 2003-343205 A

### SUMMARY OF INVENTION

### Problem to be Solved by the Invention

The undercoat prevents oxidation of the base material, and improves adhesiveness of the topcoat at the same time. The undercoat is formed of, for example, an alloy material. The topcoat improves a thermal barrier property of the base material, and is formed of, for example, a ceramic material. In the related-art, for the purpose of securing adhesiveness between the undercoat and the base material, heating treatment for diffusing the undercoat on the surface of the base material is performed after the undercoat and the topcoat are formed. However, with the heating treatment, a spot, a crack, or the like may be formed in part of the thermal barrier coating such as the topcoat in some cases.

The present invention has been made in view of the above, and has an object to provide a method for producing a turbine blade, which is capable of securing adhesiveness between thermal barrier coating and a base material and of suppressing formation of a spot, a crack, and the like in the thermal barrier coating.

### Solution to Problem

According to an embodiment of the present invention, a method for producing a turbine blade includes forming an undercoat on a surface of a base material of a turbine blade, which is formed of a Ni-based alloy material, the undercoat being formed of a metallic material having a higher oxidation-resisting property than that of the base material, performing diffusing treatment for heating the base material having the undercoat formed thereon and diffusing a part of the undercoat on the base material side, and forming a topcoat on a surface of the undercoat after the diffusing treatment is performed, the topcoat being formed of a material having a lower thermal conductivity than that of the base material and the undercoat.

According to an embodiment of the present invention, the diffusing treatment is performed before the topcoat is formed. Thus, formation of a spot, a crack, or the like in the topcoat can be suppressed. With this, adhesiveness between the thermal barrier coating and the base material can be secured, and formation of a spot, a crack, and the like in the thermal barrier coating can be suppressed.

Further, in the diffusing treatment, the base material may be heated at a heating temperature higher than a set temperature, which is set for preventing a quality of the topcoat from being degraded through heating.

According to an embodiment of the present invention, the diffusing treatment is performed before the topcoat is formed. Thus, even when the base material is heated at a temperature higher than the set temperature, a spot, a crack, or the like is prevented from being formed in the topcoat. With this, the diffusing treatment can securely be performed. Note that, as an example of quality degradation of the topcoat through heating, formation of a spot, a crack, or the like in the topcoat is conceivable.

Further, the method for producing a turbine blade may include performing stabilizing treatment by heating the base material, and performing aging treatment by heating the base material having been subjected to the stabilizing treatment. In the diffusing treatment, the base material having the undercoat formed thereon may be subjected to at least one of the stabilizing treatment and the aging treatment.

According to an embodiment of the present invention, the base material having the undercoat formed thereon may be subjected to the heating treatment as at least one of the stabilizing treatment and the aging treatment. The heating treatment may also be performed as the diffusing treatment for the undercoat. With this, the producing steps can be shortened.

Further, the method for producing a turbine blade may include performing brazing treatment by heating the base material having a brazing material arranged thereon. In the diffusing treatment, the base material having the undercoat formed thereon may be subjected to the brazing treatment and the stabilizing treatment with one heating treatment.

According to an embodiment of the present invention, as the heating treatment to which the base material is subjected, the brazing treatment and the stabilizing treatment are performed with one heating treatment. With this, the heating treatment may be performed in a shorter time period.

Further, in the diffusing treatment, the brazing treatment, the base material having the undercoat formed thereon may be sequentially subjected to the brazing treatment, the stabilizing treatment, and the aging treatment with one heating treatment.

According to an embodiment of the present invention, the base material having the undercoat formed thereon may be sequentially subjected to the brazing treatment, the stabilizing treatment, and the aging treatment with one heating treatment. With this, the heating treatment may be performed in a shorter time period.

### Advantageous Effect of Invention

According to the present invention, adhesiveness between the thermal barrier coating and the base material can be secured, and formation of a spot, a crack, and the like in the thermal barrier coating can be suppressed.

### BRIEF DESCRIPTION OF DRAWINGS

FIG. 1 is a flowchart for illustrating an example of a method for producing a turbine blade according to a first embodiment of the present invention.

FIG. 2 is a flowchart for illustrating an example of a procedure of heating treatment in Step S40.

FIG. 3 is a flowchart for illustrating an example of diffusing treatment in Step S40 of a method for producing a turbine blade according to a second embodiment of the present invention.

FIG. 4 is a graph for showing an example of a time change of a heating temperature in a case where brazing treatment and stabilizing treatment are performed with one heating treatment.

FIG. 5 is a flowchart for illustrating an example of diffusing treatment in Step S40 of a method for producing a turbine blade according to a third embodiment of the present invention.

FIG. 6 is a graph for showing an example of a time change of a heating temperature in a case where brazing treatment, stabilizing treatment, and aging treatment are sequentially performed with one heating treatment.

FIG. 7 is a graph for showing another example of a time change of a heating temperature in a case where brazing treatment, stabilizing treatment, and aging treatment are sequentially performed with one heating treatment.

FIG. 8 is a flowchart for illustrating an example of a method for producing a turbine blade according to a modified example of the present invention.

FIG. 9 is a graph for showing an example of a time change of a heating temperature in heating treatment in Step S350.

### DESCRIPTION OF EMBODIMENTS

Now, with reference to the drawings, description is made of a method for producing a turbine blade according to embodiments of the present invention. Note that, the invention is not limited to the embodiments. Further, the constituent elements in the following embodiments include those that can be easily replaced by a person skilled in the art or those that are substantially the same.

### First Embodiment

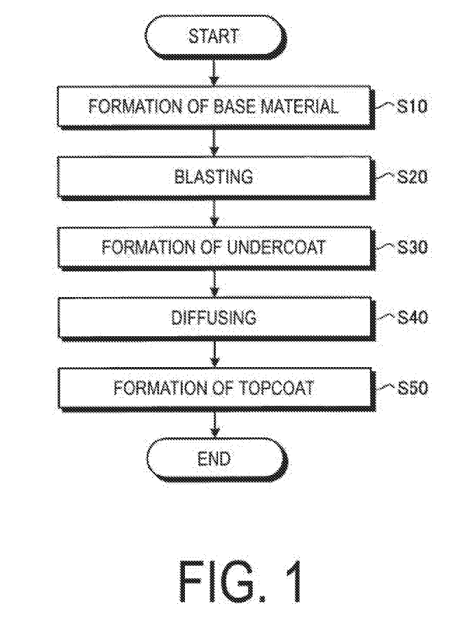

FIG. 1 is a flowchart for illustrating an example of a method for producing a turbine blade according to a first embodiment of the present invention. As illustrated in FIG. 1, the method for producing a turbine blade according to the first embodiment includes, for example, a step of forming a base material of a turbine blade such as a stator blade and a rotor blade of a gas turbine (Step S10), a step of subjecting the base material to blasting treatment (Step S20), a step of forming an undercoat on a surface of the base material (Step S30), a step of subjecting the undercoat to diffusing treatment (Step S40), and a step of forming a topcoat on a surface of the undercoat (Step S50).

In Step S10, the base material forming a turbine blade such as a stator blade and a rotor blade is formed. The turbine blades are exposed in a high temperature environment in the gas turbine. Thus, the base material forming a turbine blade is formed of an alloy having a high heat-resisting property, for example, a Ni-based alloy. As the Ni-based alloy, for example, there is exemplified a Ni-based alloy containing: from 12.0% to 14.3% of Cr; from 8.5% to 11.0% of Co; from 1.0% to 3.5% of Mo, from 3.5% to 6.2% of W; from 3.0% to 5.5% of Ta; from 3.5% to 4.5% of Al; from 2.0% to 3.2% of Ti; from 0.04% to 0.12% of C; from 0.005% to 0.05 of B; and the remnant of Ni and inevitable impurities. Further, the Ni-based alloy with the above-mentioned composition may contain from 0.001 ppm to 5 ppm of Zr. Further, the Ni-based alloy with the above-mentioned composition may contain from 1 ppm to 100 ppm of Mg and/or Ca, and further may contain one or more of the following: from 0.02% to 0.5% of Pt; from 0.02% to 0.5% of Rh; and from 0.02% to 0.5% of Re. The Ni-based alloy with the above-mentioned composition may satisfy both of those conditions.

The base material is formed of the above-mentioned material through casting, forging, and the like. When the base material is formed through casting, the base material such as a conventional casting (CC) material, a directional solidification (DS) material, and a single crystal (SC) material can be formed. In the following, description is made of a case where a directional solidification material is used as the base material as an example. However, the present invention is not limited thereto, and similar description can be given even when the base material is a conventional casting material or a single crystal material.

Note that, after the base material is formed, solutionizing treatment may be performed in which precipitate generated in the former step is solutionized to reduce component segregation. When the solutionizing treatment is performed, the base material is heated at a temperature of, for example, approximately 1200° C.

In Step S20, before the undercoat is formed on the surface of the base material, for example, alumina (Al₂O₃) is sprayed against the surface of the base material so as to roughen the surface of the base material. The base material is roughened, and hence adhesiveness between the base material and the undercoat is improved with an anchor effect. Note that, after the blasting treatment, cleaning treatment for cleaning the surface of the base material may be performed.

In Step S30, the undercoat is formed on the surface of the base material. The undercoat is a part of thermal barrier coating (TBC) for protecting a turbine blade from a high temperature. The undercoat prevents oxidation of the base material, and improves adhesiveness of the topcoat. As a material of the undercoat, for example, an alloy material such as MCrAIY having a higher oxidation-resisting property than that of the base material may be used. In Step S30, for example, after the surface of the base material is heated, the alloy material or the like is thermally sprayed against the surface of the base material. In this manner, the undercoat is formed.

In Step S40, the undercoat is subjected to the diffusing treatment. In the diffusing treatment, the undercoat is heated so that atoms forming the undercoat are diffused to the base material side. Accordingly, adhesiveness between the undercoat and the base material is improved. The diffusing treatment is performed after the undercoat is formed on the base material and before the topcoat is formed.

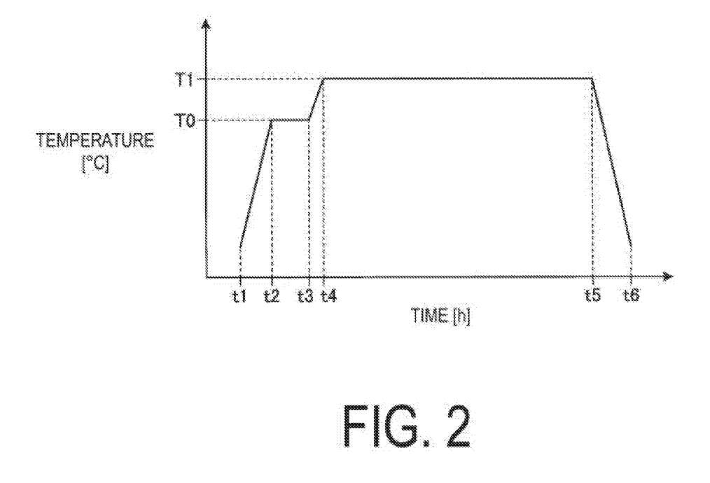

In Step S40, the base material may be subjected to heating treatment as the diffusing treatment. As the heating treatment, for example, heating treatment such as brazing treatment, stabilizing treatment, and aging treatment are exemplified. FIG. 2 is a flowchart for illustrating an example of the procedure of the heating treatment in Step S40. As illustrated in FIG. 2, in Step S40, the brazing treatment (S41), the stabilizing treatment (S43), and the aging treatment (S45) may be performed in the stated order.

In the brazing treatment in Step S41, the base material having a brazing material arranged thereon is heated, and then the brazing material is welded and joined to the base material. As the brazing material, for example, a BNi-2 equivalent material is used. In this case, for example, a solidus temperature of the brazing material is approximately 970° C. An amount of the brazing material to be used for the brazing treatment is adjusted in advance by performing tests and the like. In the brazing treatment, the heating treatment can be performed at a temperature at which the brazing material can be welded, for example, at a temperature from 1060° C. to 1100° C.

When the brazing treatment is performed, the base material having the brazing material arranged thereon is placed in a predetermined heating furnace, and a heater of the heating furnace is operated to start heating. After the heating is started, first, a furnace internal temperature (heating temperature) of the heating furnace is caused to rise to a predetermined preheating temperature. The preheating temperature is set to a temperature lower than the solidus temperature of the brazing material, and may be set to a temperature of, for example, from 930° C. to 970° C. When the furnace internal temperature reaches the preheating temperature, the rise of the furnace internal temperature is stopped, and the heating treatment (preheating treatment) is performed at the preheating temperature for a predetermined time period. With the preheating treatment, the temperatures of the base material and the brazing material rises uniformly in an entire area, and a temperature difference among the portions is reduced. After the preheating treatment is performed for a predetermined time period, the furnace internal temperature is caused to rise again. When the furnace internal temperature reaches the above-mentioned brazing temperature, the rise of the furnace internal temperature is stopped, and the heating treatment is performed at the brazing temperature for a predetermined time period. With this action, the brazing material is welded and joined to the base material. After the predetermined time period elapses, the temperature of the base material is lowered rapidly to a predetermined cooling temperature at a temperature lowering rate of, for example, approximately 30° C./min (quenching) by, for example, stopping the heater and supplying a cooling air into the heating furnace.

In the stabilizing treatment in Step S43, the base material is heated so that a γ′ phase being an intermetallic compound in the base material is increased. Accordingly, a size and a form of the γ′ phase and the like are uniformed. In the stabilizing treatment, for example, the heating treatment can be performed at a temperature equivalent to the heating temperature in the brazing treatment, for example, at a temperature from 1060° C. to 1100° C.

In the stabilizing treatment, the γ′ phase is increased in the base material, and a size and a form of the γ′ phase and the like are uniformed. When the stabilizing treatment is performed, similarly to the brazing treatment, the preheating treatment may be performed. In this case, the base material having been subjected to the preheating treatment is heated at the heating temperature of the stabilizing treatment. Thus, each portion of the base material is evenly heated. Therefore, in each portion of the base material, the γ′ phase is increased uniformly. After the stabilizing treatment is performed for a predetermined time period, the temperature of the base material is lowered rapidly to a predetermined cooling temperature at a temperature lowering rate of, for example, approximately 30° C./min (quenching) by, for example, stopping the heater and supplying a cooling air into the heating furnace. With the quenching treatment, the state of the γ′ phase (particle diameter and the like) is maintained.

In the aging treatment, the base material having been subjected to the stabilizing treatment is heated. Then, the γ′ phase increased in the base material in the stabilizing treatment is further increased, and at the same time, the γ′ phase having a smaller diameter than that of the γ′ phase generated in the stabilizing treatment is precipitated. The γ′ phase having a smaller diameter increases strength of the base material. Thus, in the aging treatment, the γ′ phase having a smaller diameter is precipitated to increase the strength of the base material. As a result, the strength and ductility of the base material are adjusted. In the aging treatment, for example, a temperature may be set to from 830° C., to 870° C. After the aging treatment is performed for a predetermined time period, the temperature of the base material is lowered rapidly to a predetermined cooling temperature at a temperature lowering rate of, for example, approximately 30° C./min (quenching) by, for example, stopping the heater of the heating furnace and supplying a cooling air into the heating furnace.

By performing the heating treatment described above, the undercoat is diffused on the roughened surface of the base material, and adhesiveness between the surface of the base material and the undercoat is improved. Note that, in the diffusing treatment in Step S40, the present invention is not limited to the case where all the three types of heating treatment including the brazing treatment, the stabilizing treatment, and the aging treatment are performed, but at least only one of the above may be performed.

In Step S50, the topcoat is formed on the surface of the undercoat. The topcoat is a part of the above-mentioned thermal barrier coating, and protects the surface of the base material from a high temperature. As a material of the topcoat, a material having a small thermal conductivity such as ceramics is used. As ceramics, a material containing, for example, zirconia as a main component is used. In Step S50, the topcoat is formed by, for example, applying the above-mentioned material to the surface of the undercoat through atmospheric plasma spraying.

As described above, in the method for producing a turbine blade according to the first embodiment, the diffusing treatment is performed before the topcoat is formed. Thus, formation of a spot, a crack, or the like in the topcoat can be suppressed. With this, adhesiveness between the thermal barrier coating and the base material can be secured, and formation of a spot, a crack, and the like in the thermal barrier coating can be suppressed.

### Second Embodiment

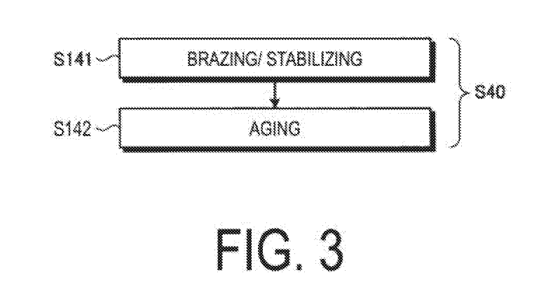

FIG. 3 is a flowchart for illustrating an example of diffusing treatment in a method for producing a turbine blade according to a second embodiment of the present invention. Similarly to the first embodiment, the method for producing a turbine blade according to the second embodiment includes Step S10 to Step S50. However, a procedure of Step S40 is different from that in the first embodiment. Now, Step S40 is mainly described.

As illustrated in FIG. 3, Step S40 includes a step of subjecting the base material having the undercoat formed thereon to one heating treatment as the brazing treatment and the stabilizing treatment (Step S141), and a step of performing the aging treatment (Step S142). The aging treatment in Step S142 is the same as that in the first embodiment. Here, the treatment in Step S141 is described.

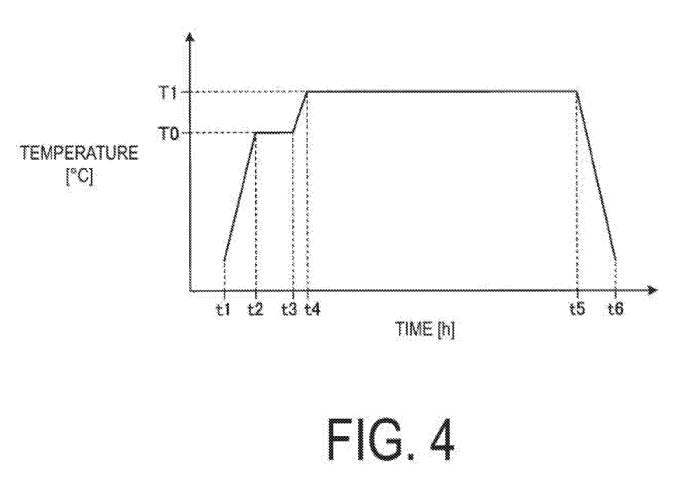

In Step S141, the brazing treatment and the stabilizing treatment are sequentially performed with one heating treatment. FIG. 4 is a graph for showing an example of the heating treatment in Step S141. In FIG. 4, a horizontal axis indicates time, and a vertical axis indicates a temperature.

As shown in FIG. 4, in Step S141, the base material having the brazing material arranged thereon is placed in a predetermined heating furnace, and a heater of the heating furnace is operated to start heating (time t1). After the heating is started, first, a furnace internal temperature (heating temperature) of the heating furnace rises to a predetermined preheating temperature T0. The preheating temperature T0 is set lower than the solidus temperature of the brazing material, and may be, for example, from 930° C. to 970° C. When the furnace internal temperature reaches the preheating temperature T0 (time t2), the rise in the furnace internal temperature is topped. Then, the heating treatment (preheating treatment) is performed at the preheating temperature T0 for a predetermined time period. With the preheating treatment, the temperatures of the base material and the brazing material rises uniformly in an entire area, and a temperature difference among the portions is reduced.

After the preheating treatment is performed for a predetermined time period (time t3), the furnace internal temperature rises again. When the furnace internal temperature reaches the first temperature T1 (time t4), a rise in the furnace internal temperature is stopped. Then, the heating treatment is performed at the first temperature T1 for a predetermined time period. With the heating treatment at the first temperature T1, the brazing material is melted and jointed to the base material. Further, in the base material, the γ′ phase can be increased, and the size and the form of the γ′ phase and the like can be uniformed. After the preheating treatment is performed, the heating is performed at the first temperature T1, and each portion of the base material is evenly heated. Thus, brazing can be performed uniformly, and the γ′ phase is increased uniformly in each portion of the base material. After the heating treatment is performed at the first temperature T1 for a predetermined time period (time t5), the temperature of the base material is lowered rapidly to a predetermined cooling temperature at a temperature lowering rate of, for example, approximately 30° C./min (quenching) by, for example, stopping the heater and supplying a cooling air into the heating furnace. With the quenching treatment, the state of the γ′ phase (particle diameter and the like) is maintained. After that, when the furnace internal temperature is lowered to a predetermined cooling temperature (time t6), the treatment in Step S30 is completed. As described above, in the first embodiment, the brazing treatment and the stabilizing treatment are performed with one heating treatment.

As described above, the brazing treatment and the stabilizing treatment are performed with one heating treatment. Accordingly, burden in the producing steps can be alleviated. Further, two kinds of treatment including the brazing treatment and the stabilizing treatment are performed collectively. Thus, efficient treatment can be achieved for a short time period.

### Third Embodiment

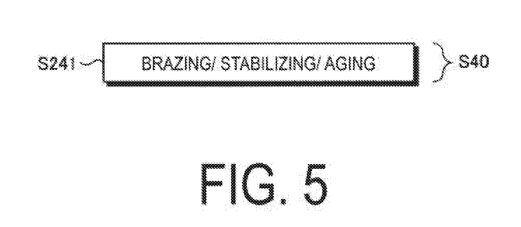

FIG. 5 is a flowchart for illustrating an example of the diffusing treatment in a method for producing a turbine blade according to a third embodiment of the present invention. Similarly to the first embodiment, the method for producing a turbine blade according to the third embodiment includes Step S10 to Step S50. However, a procedure of Step S40 is different from that in the first embodiment. Now, Step S40 is mainly described.

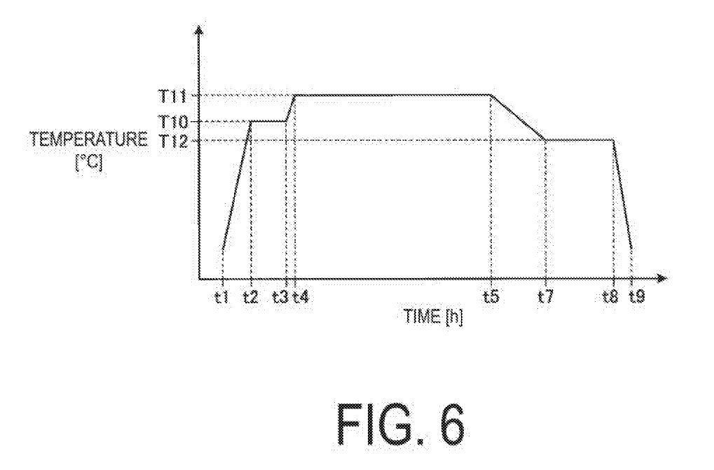

As illustrated in FIG. 5, Step S40 includes a step of performing the brazing treatment, the stabilizing treatment, and the aging treatment (Step S241). In Step S241, the brazing treatment, the stabilizing treatment, and the aging treatment are sequentially performed with one heating treatment. FIG. 6 is a graph for showing an example of the heating treatment in Step S241. In FIG. 6, a horizontal axis indicates time, and a vertical axis indicates a temperature.

In Step S241, similarly to the first embodiment, the preheating treatment is performed at the preheating temperature T0 (from time t1 to time t4), and after the preheating treatment, the heating treatment as the brazing treatment and the stabilizing treatment is performed at the first temperature T1 (from time t4 to time t5).

After the heating treatment is performed at the first temperature T1 for a predetermined time period (time t5), adjusting treatment in which the furnace internal temperature is lowered to the second temperature T2 is performed by, for example, stopping the operation of the heater. At this time, the temperature of the base material is lowered at a temperature lowering rate of, for example, from 3° C./min to 20° C./min. Therefore, as compared to the first embodiment, after the stabilizing treatment (time t5 and later), the temperature is lowered slowly.

When the furnace internal temperature reaches the second temperature T2 (time t7), the heating treatment as the aging treatment is performed under a state in which the heater is operated to set the furnace internal temperature to the second temperature T2. Thus, after the stabilizing treatment, the furnace internal temperature is shifted to the second temperature T2 for performing the aging treatment, and the aging treatment is sequentially performed without cooling the heating furnace to a predetermined cooling temperature. As described above, in the third embodiment, the brazing treatment, the stabilizing treatment, and the aging treatment are sequentially performed with one heating treatment.

Similarly to the first embodiment, in the aging treatment, for example, the heating treatment is performed at the second temperature T2 lower than the first temperature T1 for a predetermined time period. The second temperature T2 can be set to, for example, from 830° C. to 870° C. In the second embodiment, even when the temperature is lowered slowly after the stabilizing treatment, the γ′ phase is increased, and the γ′ phase having a smaller diameter is precipitated in the aging treatment, similarly to the case where the quenching is performed in the first embodiment. Thus, the base material excellent in strength and ductility is formed.

After the aging treatment is performed for a predetermined time period (time t8), the temperature of the base material is lowered rapidly to a predetermined cooling temperature at a temperature lowering rate of, for example, approximately 30° C./min (quenching) by, for example, stopping the heater of the heating furnace and supplying a cooling air into the heating furnace. After the furnace internal temperature turns to a predetermined temperature (time t9), the base material is picked up from the heating furnace. In this manner, the heating treatment is completed.

In the third embodiment, the brazing treatment, the stabilizing treatment, and the aging treatment are sequentially performed with one heating treatment. Thus, a time period of the heating treatment can further be shortened. Further, after the brazing treatment and the stabilizing treatment are performed at the first temperature T1, the adjusting treatment for adjusting the second temperature being a heating temperature for the aging treatment is performed. With this, the heat in the heating furnace can be efficiently utilized.

The technical scope of the present invention is not limited to the above-mentioned embodiments, and can be changed as appropriate without departing from the scope of the present invention. In the above-mentioned third embodiment, the base material is cooled at a temperature lowering rate of approximately from 3° C./min to 20° C./min when the adjusting treatment for lowering the furnace internal temperature to the second temperature T2 is performed after the stabilizing treatment. However, the present invention is not limited thereto.

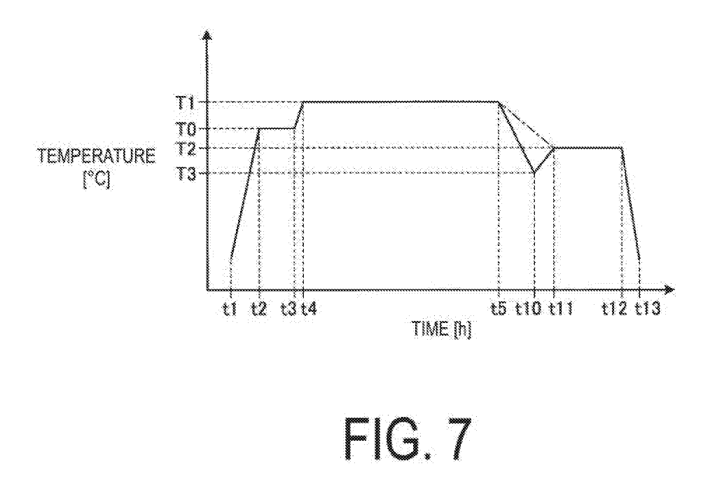

FIG. 7 is a graph for showing another example of a time change of the furnace internal temperature in a case where the brazing treatment, the stabilizing treatment, and the aging treatment are sequentially performed with one heating treatment. As shown in FIG. 7, in a case where the furnace internal temperature becomes a third temperature T3 lower than the second temperature T2 (time t10) by cooling an inside of the heating furnace at a cooling rate of, for example, approximately 30° C./min after the stabilizing treatment, the heater may be operated. The third temperature T3 can be set to a temperature of, for example, from approximately 530° C. to approximately 570° C.

After the heater is operated, when the furnace internal temperature rises to reach the second temperature T2 (time t11), a rise in the furnace internal temperature is stopped, and the aging treatment is performed in the heating furnace at the second temperature T2. The procedure thereafter is similar to that in the second embodiment. That is, after the aging treatment is performed for a predetermined time period (time t12), the temperature of the base material is lowered rapidly to a predetermined cooling temperature at a temperature lowering rate of, for example, approximately 30° C./min (quenching) by, for example, stopping the heater of the heating furnace and supplying a cooling air into the heating furnace. After the furnace internal temperature turns to a predetermined temperature (time t13), the base material is picked up from the heating furnace. In this manner, the heating treatment is completed. Even when the temperature changes as described above, a time period for the heating treatment can be shortened. Further, after the brazing treatment and the stabilizing treatment are performed at the first temperature T1, the adjusting treatment for adjusting the second temperature T2 being a heating temperature for the aging treatment is performed. With this, the heat in the heating furnace can efficiently be utilized. Note that, after the stabilizing treatment, when the base material is cooled at a temperature lowering rate of, for example, approximately 30° C./min to turn the furnace internal temperature to the second temperature T2, the aging treatment may be performed in the heating furnace at the second temperature T2.

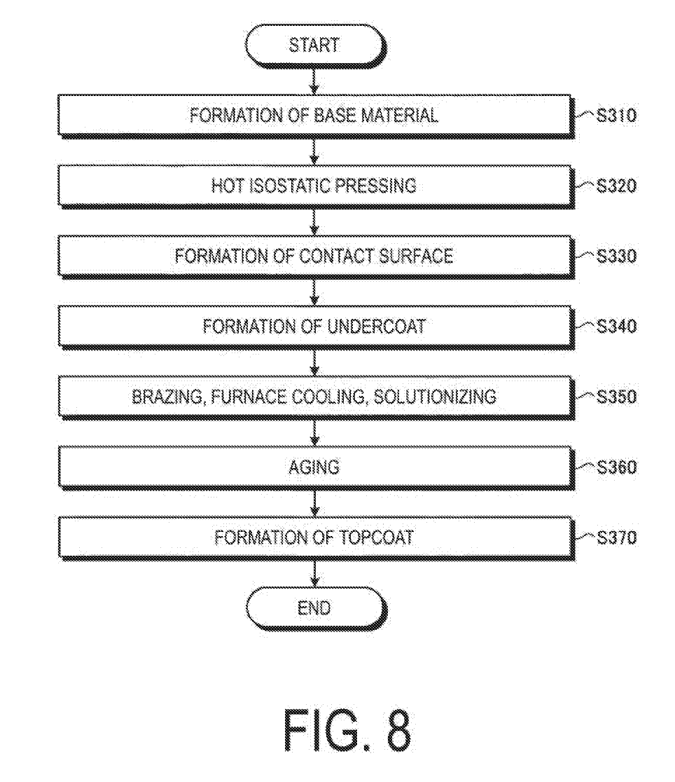

Further, in the above-mentioned embodiments, description is made of a case where a directional solidification material is used as the base material as an example. However, the present invention is not limited thereto, and, for example, a conventional casting material may be used as the base material. FIG. 8 is a flowchart for illustrating an example of a method for producing a turbine blade according to a modified example of the present invention. As illustrated in FIG. 8, the method for producing a turbine blade according to the modified example includes a step of forming the base material through use of a conventional casting material (Step S310), a step of subjecting the base material to hot isostatic pressing treatment (Step S320), a step of forming wear-resisting coating on the surface of the base material (Step S330), a step of forming the undercoat on the base material and a surface of the wear-resisting coating (Step S340), a step of subjecting the base material to the brazing treatment and the solutionizing treatment (Step S350), a step of subjecting the base material to the aging treatment (Step S360), and a step of forming the topcoat on the base material (Step S370). In this modified example, Step S350 and Step S360 are performed as the diffusing treatment.

In the hot isostatic pressing (HIP) treatment in Step S320, the base material is heated at a temperature of, for example, from 1180° C. to 1220° C. under a state of being placed in an argon gas atmosphere. With this, heating is performed under a state in which an entire surface of the base material is equally pressurized. After the hot isostatic pressing treatment is completed, the temperature of the base material is lowered by stopping the heating (quenching). Note that, after Step S320, treatment similar to the solutionizing treatment to be described later may be performed.

In Step S330, as the wear-resisting coating, for example, a cobalt-based wear-resisting material such as Triballoy (trade name) 800 may be used. In Step S320, a layer formed of the above-mentioned material may be formed on the base material with a method such as atmospheric plasma spraying, high-velocity flame spraying, low-pressure plasma spraying, and atmospheric plasma spraying.

In Step S340, the undercoat is formed on the base material with the same method as that in the above-mentioned embodiments.

In Step S350, the base material is subjected to the brazing treatment, and subjected to the solutionizing treatment after quenching. In the brazing treatment, the base material having a brazing material arranged thereon is heated, and then the brazing material is welded and joined to the base material. As the brazing material, a material such as Amdry (trade name) DF-6A is used. In this case, the solidus temperature of the brazing material is, for example, approximately 1050° C. An amount of the brazing material to be used for the brazing treatment is adjusted in advance by performing tests and the like. In the brazing treatment, the heating treatment can be performed at a temperature at which the brazing material can be welded (T21), for example, at a temperature from 1175° C. to 1215° C.

In the solutionizing treatment, the base material is heated so that the γ′ phase being an intermetallic compound in the base material is solutionized and increased. In the solutionizing treatment, for example, the heating treatment may be performed at a temperature (T22) lower than the heating temperature in the brazing treatment, for example, at a temperature from 1100° C. to 1140° C.

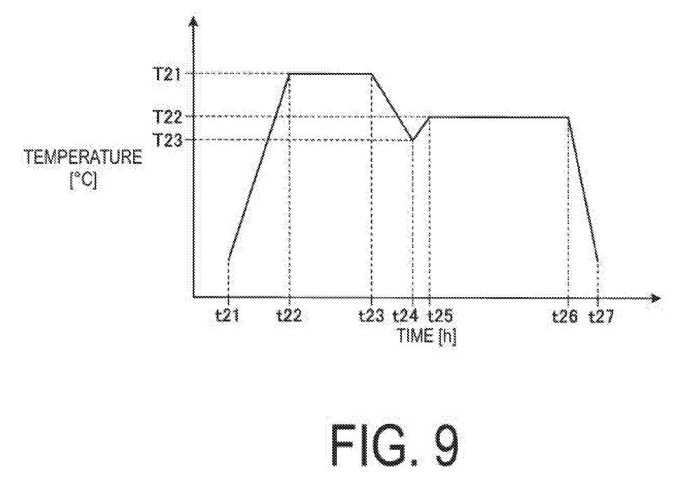

FIG. 9 is a graph for showing an example of a time change of a heating temperature in the heating treatment in Step S350. In FIG. 9, a horizontal axis indicates time, and a vertical axis indicates a temperature. In Step S350, first, the brazing treatment is performed. In the brazing treatment, the base material having the brazing material arranged thereon is placed in a predetermined heating furnace, and a heater of the heating furnace is operated to start heating (time t21). When the furnace internal temperature (heating temperature) of the heating furnace reaches the above-mentioned temperature T21 (time t22), the rise of the furnace internal temperature is stopped, and the heating treatment is performed at the temperature T21 for a predetermined time period. With this action, the brazing material is welded and joined to the base material.

Note that, the heating treatment (preheating treatment) may be performed at the preheating temperature for a predetermined time period after the base material is placed in the heating furnace and the furnace internal temperature is caused to rise to a predetermined preheating temperature. The preheating temperature in this case is set to a temperature lower than the solidus temperature of the brazing material, and may be set to a temperature of, for example, 1030° C. Note that, the preheating temperature may appropriately be changed in accordance with the solidus temperature of the brazing material. With the preheating treatment, the temperatures of the base material and the brazing material rises uniformly in an entire area, and a temperature difference among the portions is reduced. When the preheating treatment is performed for a predetermined time period, the furnace internal temperature is caused to rise to the temperature T21 after the preheating treatment. In this manner, the brazing treatment is performed.

After the brazing treatment is performed for a predetermined time period (time t23), the temperature of the base material is lowered to a temperature T23 lower than the temperature T22 in the solutionizing treatment at a temperature lowering rate of approximately from 3° C./min to 20° C./min (annealing) by, for example, stopping the heater. The temperature T23 may be a temperature of, for example, from 980° C. to 1020° C. Through annealing, formation of a void in a brazing portion is suppressed.

After the furnace internal temperature reaches the temperature T23 through annealing, the adjusting treatment for causing the furnace internal temperature to rise is performed (time t24). In the adjusting treatment, the heater is operated so that the furnace internal temperature is caused to rise to the temperature T22. When the furnace internal temperature rises to the temperature T22 (time t25), the rise of the furnace internal temperature is stopped, and the solutionizing treatment is performed at the temperature T22 in the heating furnace. After the solutionizing treatment is performed for a predetermined time period, for example, the heater is stopped, and a cooling air is supplied into the heating furnace (time t26). The temperature of the base material is lowered rapidly to a predetermined cooling temperature at a temperature lowering rate of, for example, approximately 30° C./min (quenching) by supplying a cooling air. With the quenching treatment, the state of the γ′ phase (particle diameter and the like) is maintained. After the furnace internal temperature reaches a predetermined temperature (time t27), the base material is taken out from the heating furnace. Then, Step S340 is completed. Note that, in Step S340, the brazing treatment and the solutionizing treatment are separately performed.

Note that, through the heating treatment in Step S350, the wear-resisting coating and the oxidation-resisting coating are diffused on the surface of the base material. Accordingly, adhesiveness between the surface of the base material and each coating is improved.

In the aging treatment in Step S360, similarly to the above-mentioned embodiments, a temperature may be set to, for example, from 830° C. to 870° C. After the aging treatment is performed for a predetermined time period, the temperature of the base material is lowered rapidly to a predetermined cooling temperature at a temperature lowering rate of, for example, approximately 30° C./min (quenching) by, for example, stopping the heater of the heating furnace and supplying a cooling air into the heating furnace.

By performing the heating treatment described above, the undercoat is diffused on the roughened surface of the base material, and adhesiveness between the surface of the base material and the undercoat is improved.

In Step S370, the topcoat is formed on the surface of the undercoat with the same method as that in the above-mentioned embodiments.

In the above-mentioned method for producing a turbine blade, the diffusing treatment is performed before the topcoat is formed. Thus, formation of a spot, a crack, or the like can be suppressed. With this, adhesiveness between the thermal barrier coating and the base material can be secured, and formation of a spot, a crack, and the like in the thermal barrier coating can be suppressed.

### REFERENCE SIGNS LIST

T0 Preheating temperature
T1 First temperature
T2 Second temperature

1. A method for producing a turbine blade, comprising:
forming an undercoat on a surface of a base material of a turbine blade, which is formed of a Ni-based alloy material, the undercoat being formed of a metallic material having a higher oxidation-resisting property than an oxidation-resisting property of the base material;
performing diffusing treatment for heating the base material having the undercoat formed thereon and diffusing a part of the undercoat on the base material side; and
forming a topcoat on a surface of the undercoat after the diffusing treatment is performed,
wherein the diffusing treatment includes:
a stabilizing treatment for heating the base material; and
a quenching treatment for rapidly cooling a temperature of the base material at a predetermined temperature lowering rate by supplying a cooling air after the stabilizing treatment.

2. The method for producing a turbine blade according to claim 1, wherein, in the diffusing treatment, the base material is heated at a heating temperature higher than a set temperature, which is set for preventing a quality of the topcoat from being degraded through heating.

3. The method for producing a turbine blade according to claim 1, further comprising
performing aging treatment by heating the base material having been subjected to the stabilizing treatment,
wherein, in the diffusing treatment, the base material having the undercoat formed thereon is subjected to at least one of the stabilizing treatment and the aging treatment with one heating treatment, and the quenching treatment is performed after the one heating treatment.

4. The method for producing a turbine blade according to claim 3, further comprising performing brazing treatment by heating the base material having a brazing material arranged thereon,
wherein, in the diffusing treatment, the base material having the undercoat formed thereon is subjected to the brazing treatment and the stabilizing treatment with one heating treatment, and the quenching treatment is performed after the one heating treatment.

5. The method for producing a turbine blade according to claim 4, wherein, in the diffusing treatment, the base material, which has the undercoat formed thereon, is sequentially subjected to the brazing treatment, the stabilizing treatment, and the aging treatment with one heating treatment, and the quenching treatment is performed after the one heating treatment.
